(19) United States
(12) Patent Application Publication
(10) Pub. No.: US 2026/0163810 A1
(43) Pub. Date: Jun. 11, 2026

(54) GENERATIVE ARTIFICIAL INTELLIGENCE BASED LANGUAGE MODELS FOR WIRELESS COMMUNICATION

(71) Applicant: QUALCOMM Incorporated, San Diego, CA (US)

(72) Inventors: Himanshu JOSHI, San Jose, CA (US); June NAMGOONG, San Diego, CA (US); Taesang YOO, San Diego, CA (US); Vinay CHANDE, San Diego, CA (US)

(21) Appl. No.: 18/974,953

(22) Filed: Dec. 10, 2024

(51) Int. Cl. H04L 41/16; H04W 24/02

(52) U.S. Cl. CPC H04L 41/16; H04W 24/02

(57) ABSTRACT

A user equipment (UE) generates an input token sequence associated with wireless communication data between the UE and a network unit, configuration data associated with the UE, or configuration data associated with the network unit. The UE obtains one or more predicted next tokens representing predicted wireless communication data from one or more generative artificial intelligence (AI) based language models using the input token sequence, wherein the one or more generative AI based language models are pretrained with a dataset comprising data token sequences associated with wireless protocol data. The UE generates one or more communication parameters for future wireless communication by the UE, based at least in part on the one or more predicted next tokens.

### TECHNICAL FIELD

This application relates to wireless communication systems, and more particularly to using generative artificial intelligence (AI) based language models for one or more of wireless communication or wireless configuration.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as mmWave bands. NR is also designed to operate across different spectrum types, from licensed spectrum to unlicensed and shared spectrum.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

To achieve low latency and high reliability demands of wireless communication systems, a UE or a network unit such as a base station (BS) may be configured with various parameters for data transmission and reception. However, some information related to the communication link or channel between the UE and the network unit, referred to as the UE-BS link adaptation, and by extension, the quality of service (QoS), may not be directly observable by the UE. Similarly, some information related to UE-side settings may not be observable by the network unit. Accordingly, in some cases, the UE or the network unit may rely on assumptions about the communication link, the UE side settings or the network side settings based on the channel and traffic conditions that are observable by the UE or the network unit, respectively for configuring wireless communications on the communication link. In some cases, the assumptions about the communication link or the settings can result in suboptimal performance of the wireless communication between the UE and the network unit.

One or more aspects described herein may provide a generative AI based language model that may be pretrained on a dataset associated with wireless communication between the UE and the network unit across various UE and network configuration data. The pretrained generative AI based language model may be used by the UE or the network to predict wireless communication performance characteristics, or configuration data, e.g., for future use by the UE or the network. For example, the generative AI based language model may be based on a neural network architecture that may generate a predicted distribution of a next token in response to an input sequence of tokens representing tokenized wireless signaling data that the UE receives or monitors. The generated tokens may represent predicted wireless configuration data or wireless protocol interaction data related to, for example, the UE side settings or the communication link with the network unit.

For example, in an aspect of the disclosure, a user equipment (UE) comprises one or more memories and one or more processors coupled to the one or more memories, the one or more memories storing instructions that are executable by the one or more processors. The processors are configured individually or in any combination, to cause the UE to generate an input token sequence associated with one or more of wireless communication data between the UE and a network unit, configuration data associated with the UE, or configuration data associated with the network unit, obtain one or more predicted next tokens representing predicted wireless communication data from one or more generative artificial intelligence (AI) based language models using the input token sequence, the one or more generative AI-based language models pretrained with a dataset comprising data token sequences associated with wireless protocol data, and generate one or more communication parameters for future wireless communication by the UE, based at least in part, on the one or more predicted next tokens.

For another example, in an aspect of the disclosure, a network unit comprises one or more memories and one or more processors coupled to the one or more memories, the one or more memories storing instructions that are executable by the one or more processors. The processors are configured individually or in any combination, to cause the network unit to generate an input token sequence associated with one or more of wireless communication data between the network unit and one or more UEs that the network unit is serving, configuration data associated with the network unit or configuration data associated with the one or more UEs, obtain one or more predicted next tokens representing predicted wireless communication data from one or more generative artificial intelligence (AI) based language models using the input token sequence, the one or more generative AI-based language models pretrained with a dataset comprising data token sequences associated with wireless protocol data, and generate one or more communication parameters for future wireless communication by the network unit, based at least in part, on the one or more predicted next tokens.

In an additional aspect of the disclosure, a method of wireless communication is disclosed, comprising generating an input token sequence associated with one or more of wireless communication data between the UE and a network unit, configuration data associated with the UE, or configuration data associated with the network unit, obtaining one or more predicted next tokens representing predicted wireless communication data from one or more generative artificial intelligence (AI) based language models using the input token sequence, the one or more generative AI-based language models pretrained with a dataset comprising data token sequences associated with wireless protocol data, and generating one or more communication parameters for future wireless communication by the UE, based at least in part, on the one or more predicted next tokens.

In an additional aspect of the disclosure, a method of wireless communication is disclosed, comprising generating an input token sequence associated with one or more of wireless communication data between the network unit and one or more UEs that the network unit is serving, configuration data associated with the network unit or configuration data associated with the one or more UEs, obtaining one or more predicted next tokens representing predicted wireless communication data from one or more generative artificial intelligence (AI) based language models using the input token sequence, the one or more generative AI-based language models pretrained with a dataset comprising data token sequences associated with wireless protocol data, and generating one or more communication parameters for future wireless communication by the network unit, based at least in part, on the one or more predicted next tokens.

Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain aspects or embodiments and figures below, all aspects and embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary aspects and embodiments may be discussed below as device, system, or method embodiments it should be understood that such exemplary aspects and embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates an example disaggregated base station architecture according to some aspects of the present disclosure.

FIG. 3 illustrates a radio frame structure according to some aspects of the present disclosure.

FIG. 4A is a simplified diagram illustrating an example pretraining framework to train a generative AI based language model on a dataset of tokenized wireless communication data, according to aspects described herein.

FIG. 4B is a simplified diagram illustrating using a generative AI based language model trained by the framework in FIG. 4A to predict wireless configuration data, according to aspects described herein.

FIG. 5A is a simplified diagram illustrating an example training framework to finetune one or more task-specific neural network modules with the trained generative AI based language model trained in FIG. 4A on a dataset of specific tokenized wireless communication data, according to aspects described herein.

FIG. 5B is a simplified diagram illustrating using the finetuned task-specific neural network modules finetuned using the framework shown in FIG. 5A to predict one or more particular types of performance metrics, according to aspects described herein.

FIG. 6 is an illustrative block diagram of an example machine learning (ML) model represented by an artificial neural network (ANN).

FIG. 7 is an illustrative block diagram of an example ML architecture that may be used for wireless communications in any of the various implementations, processes, environments, networks, or use cases listed above.

FIG. 8 is an illustrative block diagram of an example ML architecture of a first wireless device in communication with a second wireless device.

FIG. 9 is a block diagram of an exemplary user equipment (UE) according to some aspects of the present disclosure.

FIG. 10 is a block diagram of an exemplary network unit according to some aspects of the present disclosure.

FIG. 11 provides an example diagram illustrating an example tokenized sequence representing wireless communication or configuration data similar to the input sequence of tokens described in FIGS. 4A-5B, according to aspects described herein.

FIG. 12 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, future communication networks such as 5G advanced, 6G, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, 6G and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a Ultra-high density (e.g., ˜1M nodes/km2), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, or as instructions stored on a computer readable medium for execution on a processor or computer. Furthermore, an aspect may comprise at least one element of a claim.

In wireless communication systems such as, for example, 3GPP 5th Generation (5G)/New Radio (NR) or 6G, a User Equipment (UE) may need to be configured with various parameters for data transmission and reception. Example configuration parameters a UE might need to be configured with, include frequency band and bandwidth part for uplink transmission, physical resource block (PRB) allocation, resource allocation type (Type 0, Type 1, Type 2), modulation and coding scheme (MCS) index for determining the modulation order (e.g., QPSK, 16QAM, 64QAM, 256QAM), coding rate, or the like. However, some information affecting the efficacy of UE-BS (also referred to as gNodeB or gNB throughout this disclosure) link adaptation, and by extension, the quality of service (QoS), may not be directly observable by the UE. For example, such information can include, for example, gNB side settings such as scheduler parameters, load on the gNB, presence of an outer loop, outer loop target, inner loop, congestion in the network, delays in the network, proportionally fair parameter gNB, other UE's traffic presence, other UE's class of traffic, interference at the gNB from other UEs and gNBs or the like. Similarly, some information may not be directly observable by or signaled to the gNB, such as, but not limited to, UE side parameters like user intention, UE side channel, or the like.

Consequently, either the UE or gNB may make certain assumptions about the other side for communication data that is not observable or otherwise signaled to them, respectively, while configuring their respective communication parameters. This may result in, at times, suboptimal performance at the physical, link or traffic levels. For example, a lack of coordination for interference management by gNB to coordinate with transmission with several UEs may result in higher levels of inter-cell interference, and thus degrade the signal quality and reduce the overall network throughput.

Exemplary aspects described herein may provide a generative AI language model that may be pretrained on a dataset associated with wireless communication between UE-gNB across various gNB configuration data to predict wireless communication performance characteristics, and/or configuration data, e.g., for future use by the UE or the gNB. For example, the training dataset may comprise historical wireless communication data between UE-gNB interactions, synthetic wireless data (such as from system-level simulation of UE-gNB interactions), wireless data generated by a generative AI based model, and/or the like.

In one exemplary aspect, the generative AI based language model may be built upon a neural network architecture, which comprises a decoder-only Transformer model that may output a predicted distribution of a next token in response to an input sequence of tokens.

In one exemplary aspect, the generative AI based language model may be deployed at a UE side. When the input sequence of tokens represent wireless signaling data (e.g., wireless over the air (OTA) data) that UE receives or observes, such as, but not limited to channel quality indicator (CQI) reports, decoded grants from gNB, UE hybrid automatic repeat request (HARQ) Acknowledgement/Non-Acknowledgement (A/N) per grant, absence of all activity (e.g., when no activity is observed during a given period of time), etc., the output tokens may represent predicted wireless configuration data or wireless protocol interaction data that UE can be operating at or communicating with the gNB. In addition, the input sequence of tokens may comprise tokens representing intents of either speaker, QoS/traffic class, or the like.

In one exemplary aspect, the generative AI based language model may be deployed at a gNB side. In that case, the input sequence of tokens may represent wireless signaling data (e.g., wireless over the air (OTA) data) that the gNB receives or observes, or UE-side wireless communication data that is signaled to the gNB from one or more UEs that the network unit is serving at the current communication slot. The predicted output tokens may represent predicted wireless configuration data for the gNB or wireless protocol interaction data that the gNB can be operating at or communicating with one or more UEs the gNB is currently supporting.

In some aspects, the generative AI based language model is trained using wireless protocol data or configuration data between UE and gNB that is represented by a sequence of tokens. The trained generative AI based language model may be deployed at UE side to predict a distribution over a vocabulary of wireless protocol tokens (“wireless language”) representing wireless configuration data in response to an input sequence of tokens representing link operation status between UE and gNB.

In some aspects, the generative AI based language model may generate a series of output tokens indicating a current scenario that the UE is operating under, including predicting gNB side settings not directly observed by the UE, such as gNB scheduler parameters, log on gNB, fair parameter gNB, or the like. The token generation may be performed auto-regressively, i.e., a generated token is appended to the input sequence for generating the next token.

In some aspects, different task-specific heads, such as neural network modules that have a smaller size than the generative AI based deep learning model (e.g., fewer layers, fewer neurons, fewer weights, less complicated computational structure, etc.) can be added to and finetuned in conjunction with the pretrained generative AI based language model to predict various quantitative performance metrics of the connection between the UE and gNB, such as throughput, latency, gNB excess capacity, etc.

For example, certain aspects and techniques as described herein may be implemented, at least in part, using an artificial intelligence (AI) program, such as a program that includes a machine learning (ML) or artificial neural network (ANN) model. An example ML model, such as, for example, the neural network based or generative AI based deep learning language model described throughout the disclosure, may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model, such as the generative AI based language model described throughout the disclosure, may be configured to provide computing capabilities for wireless communications and may enhance such communications in various aspects as described herein. Such an ML model may be configured with weights and biases to predict one or more tokens representing wireless configuration data for a UE. Thus, during operation of a device, the ML model may receive input data (such as a tokenized sequence representing wireless communication data in the current slot, such as but not limited to UE channel quality indicator (CQI) reports, decoded grants from gNB, UE HARQ per grant, absence of all activity, or the like), and make inferences to generate a series of predicted of tokens representing wireless communication and/or configuration data (such as but not limited to downlink (DL) grant, DL modulation and coding scheme (MCS), uplink (UL) rank, UL CQI, HARQ, or the like), based on the weights and biases.

ML models may be deployed in one or more devices (for example, network entities and user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as, for example, signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values.

For example, the ML models may comprise a generative AI-based language model. As used herein, the term “generative AI-based language model” may refer to a neural network based language model that may be pretrained with a large corpus of natural language, machine language, or tokenized wireless data to generate output tokens representing a natural language text, a machine language snippet, or otherwise wireless data in future scenarios or configuration. Such output tokens are not otherwise pre-defined, or exist in the input data to the generative AI-based language model, and hence the generative AI-based language model is “generative” with respect to the output tokens. The generative AI-based language model is different from a non-generative AI model, such as a classification model that predicts which one of a pre-define set of classes an input item belongs to, as the predicted output of the classification model is already pre-defined and known.

As used herein, the term “Large Language Model” (LLM) may refer to a generative AI based language model, such as a neural network based deep learning system designed to understand and generate human and machine languages.

An LLM may adopt a Transformer architecture that often entails a significant number of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software or hardware, e.g., including an application-specific integrated circuit (ASIC) such as a Tensor Processing Unit (TPU).

Some example ML models configured for performing such tasks described herein may include ANNs such as convolutional neural networks (CNNs) and recurrent neural networks (RNNs), transformers, diffusion models, regression analysis models (such as statistical models), decision tree learning (such as predictive models), support vector networks (SVMs), and probabilistic graphical models (such as a Bayesian network), etc. In some aspects of this disclosure, one ML model for processing the input data is an LLM, which is trained to process tokenized wireless communication and settings data in the form of a sequence of tokens, in a similar way as natural language processing. This may improve the efficiency of processing wireless communication data and utilize LLMs to predict wireless configuration data for UEs and/or network entities such as gNBs.

The description herein illustrates, by way of some examples, how one or more tasks or problems in wireless communications may benefit from the application of one or more ML models to predict wireless configuration data for a UE to configure transmission or reception in future slots. Using the ML model prediction described throughout the disclosure, UE may proactively predict wireless configuration data as well as other interaction data even in the absence of some gNB-side features. UE may independently choose to determine a more optimal set of values for gNB configuration based on predicted future behavior of the gNB or future predicted conditions of the gNB/channel/traffic or the like, even if such gNB side conditions or features are usually not signaled to the UE. The predicted configuration data may be used to configure future communication of the UE with the gNB with improved communication quality. Wireless communication technology may thus be improved.

To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “deep learning model,” “algorithm,” or the like are intended to be interchangeable.

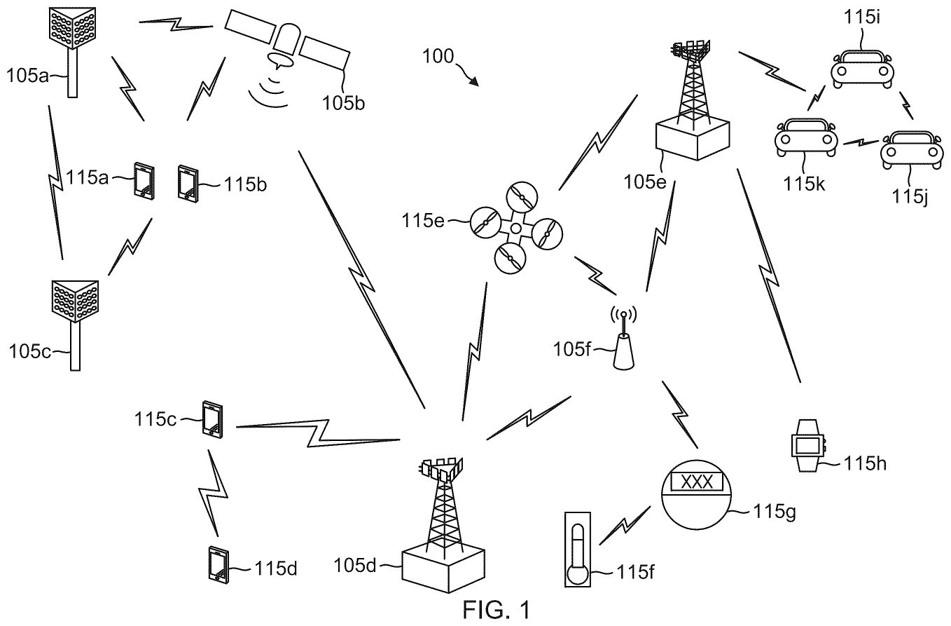

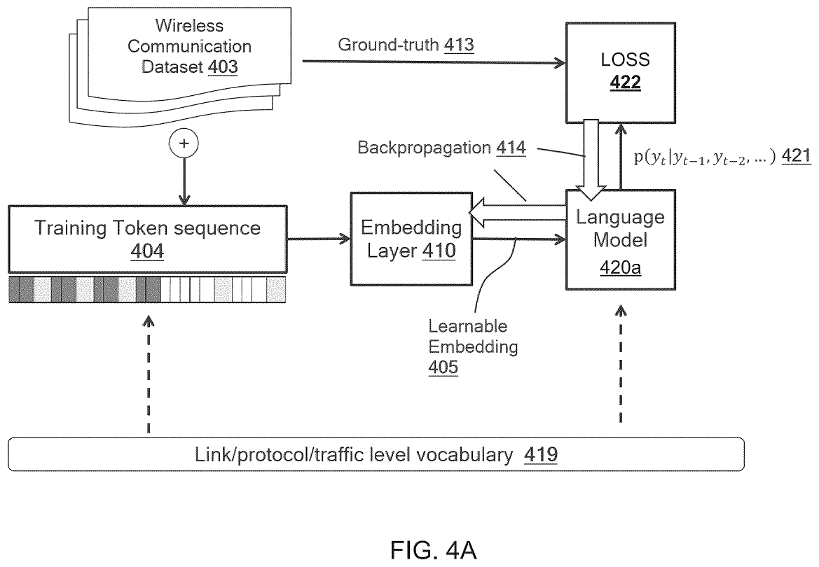

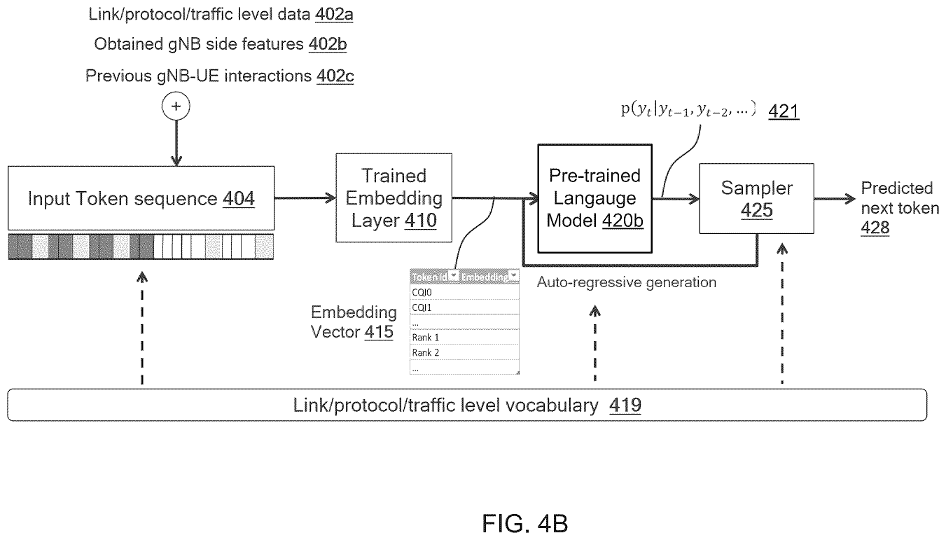

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 or a BS subsystem serving the coverage area, depending on the context in which the term is used. The actions of FIGS. 4-6 may be performed by any of UEs 115.

A BS 105 may provide communication coverage for a macro cell or a small cell, such as a pico cell or a femto cell, or other types of cells. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105b, 105d, and 105e may be regular macro BSs, while the BSs 105a and 105c may be macro BSs enabled with one of three dimension (3D), full dimension (FD), or massive MIMO. The BSs 105a and 105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, an Internet of Things (IoT) device, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) or uplink (UL), desired transmission between BSs 105, backhaul transmissions between BSs, or sidelink transmissions between UEs 115.

In operation, the BSs 105a and 105c may serve the UEs 115a and 115b using 3D beamforming and coordinated spatial techniques, such as coordinated multipoint (COMP) or multi-connectivity. The macro BS 105d may perform backhaul communications with the BSs 105a and 105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support communications with ultra-reliable and redundant links for devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-V2X (C-V2X) communications between a UE 115i, 115j, or 115k and other UEs 115, or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, or the MIB in the form of synchronization signal block (SSBs) over a physical broadcast channel (PBCH) and may broadcast the RMSI or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI or OSI. After decoding the MIB, the UE 115 may receive RMSI or OSI. The RMSI or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL or DL communications. The BS 105 may transmit UL or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH or PUCCH according to a UL scheduling grant.

In some aspects, the BS 105 may communicate with a UE 115 using hybrid automatic repeat request (HARQ) techniques to improve communication reliability, for example, to provide an ultra-reliable low-latency communication (URLLC) service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ acknowledgement (ACK) to the BS 105. Conversely, if the UE 115 fails to receive the DL transmission successfully, the UE 115 may transmit a HARQ negative acknowledgement (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a high frequency band, for example, in a frequency range 1 (FR1) band or a frequency range 2 (FR2) band. FR1 may refer to frequencies in the sub-6 GHz range and FR2 may refer to frequencies in the mmWave range. To overcome the high path-loss at high frequency, the BSs 105 and the UEs 115 may communicate with each other using directional beams. For instance, a BS 105 may transmit SSBs by sweeping across a set of predefined beam directions and may repeat the SSB transmissions at a certain time interval in the set of beam directions to allow a UE 115 to perform initial network access.

In some aspects, the network 100 may be an IoT network and the UEs 115 may be IoT nodes, such as smart printers, monitors, gaming nodes, cameras, audio-video (AV) production equipment, industrial IoT devices, or the like. The transmission payload data size of an IoT node typically may be relatively small, for example, in the order of tens of bytes. In some aspects, the network 100 may be a massive IoT network serving tens of thousands of nodes (e.g., UEs 115) over a high frequency band, such as a FR1 band or a FR2 band.

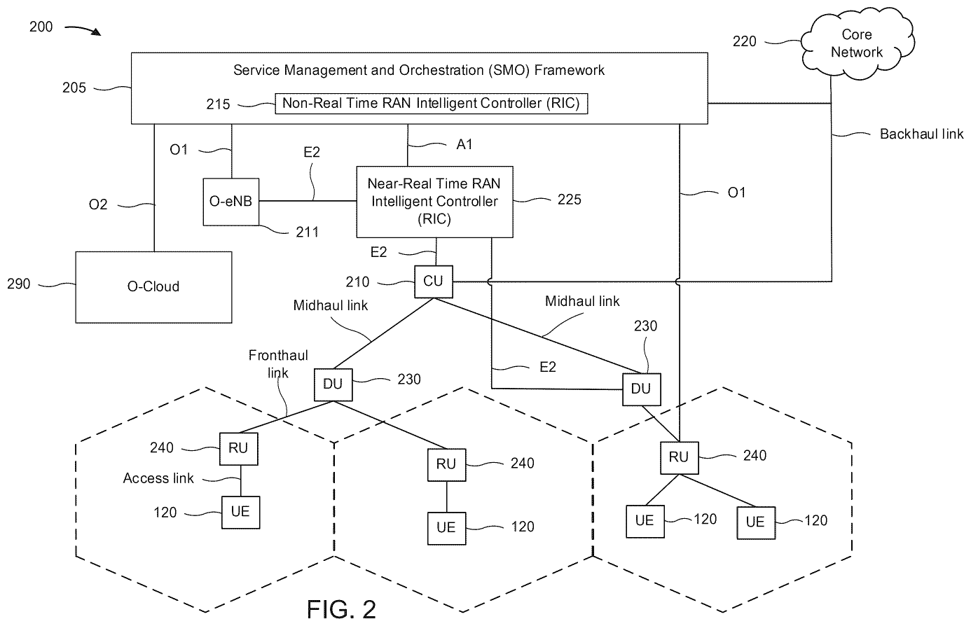

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (Rus) 240 via respective fronthaul links. The Rus 240 may communicate with respective UEs 115 via one or more radio frequency (RF) access links. In some implementations, the UE 115 may be simultaneously served by multiple Rus 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more Rus 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 115. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, Rus 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more Rus 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In some aspects, a first UE 115 may receive a cross link interference (CLI) measurement resource configuration from the RU 240, DU 230, or CU 210. In some aspects, the CLI measurement resource configuration may indicate a plurality of CLI measurement occasions. The first UE 115 may measure CLI associated with a second UE 115 in the plurality of CLI measurement occasions and transmit one or more CLI measurement reports associated with the measured CLI to the RU 240, DU 230, or CU 210.

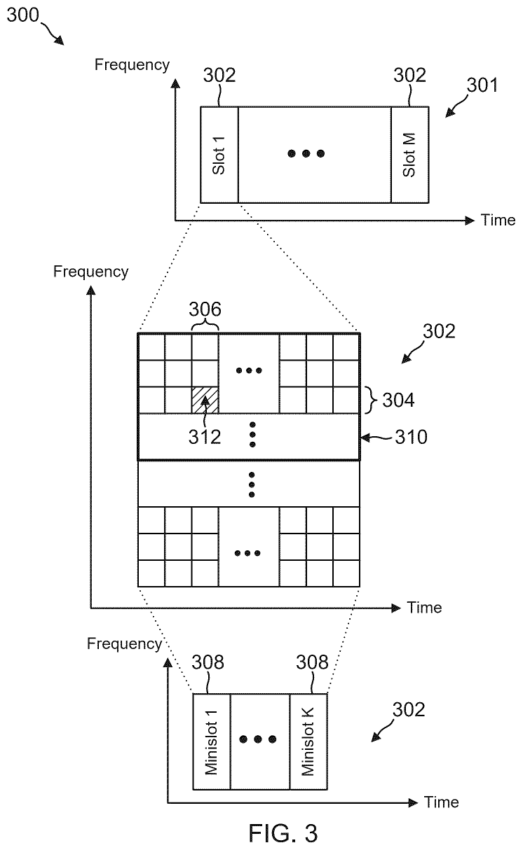

FIG. 3 is a timing diagram illustrating a radio frame structure 300 according to some aspects of the present disclosure. The radio frame structure 300 may be employed by BSs such as the BSs 105 and UEs such as the UEs 115 in a network such as the network 100 for communications. In particular, the BS may communicate with the UE using time-frequency resources configured as shown in the radio frame structure 300. In FIG. 3, the x-axes represent time in some arbitrary units and the y-axes represent frequency in some arbitrary units. The transmission frame structure 300 includes a radio frame 301. The duration of the radio frame 301 may vary depending on the aspects. In an example, the radio frame 301 may have a duration of about ten milliseconds. The radio frame 301 includes M number of slots 302, where M may be any suitable positive integer. In an example, M may be about 10.

Each slot 302 includes a number of subcarriers 304 in frequency and a number of symbols 306 in time. The number of subcarriers 304 or the number of symbols 306 in a slot 302 may vary depending on the aspects, for example, based on the channel bandwidth, the subcarrier spacing (SCS), or the cellular processor (CP) mode. One subcarrier 304 in frequency and one symbol 306 in time forms one resource element (RE) 312 for transmission. A resource block (RB) 310 is formed from a number of consecutive subcarriers 304 in frequency and a number of consecutive symbols 306 in time.

In an example, a network unit (e.g., BS 105 in FIG. 1, CU 210, or DU 230 in FIG. 2) may schedule a UE (e.g., UE 115 in FIG. 1) for UL or DL communications at a time-granularity of slots 302 or mini-slots 308. Each slot 302 may be time-partitioned into K number of mini-slots 308. Each mini-slot 308 may include one or more symbols 306. The mini-slots 308 in a slot 302 may have variable lengths. For example, when a slot 302 includes N number of symbols 306, a mini-slot 308 may have a length between one symbol 306 and (N−1) symbols 306. In some aspects, a mini-slot 308 may have a length of about two symbols 306, about four symbols 306, or about seven symbols 306. In some examples, the BS may schedule UE at a frequency-granularity of a resource block (RB) 310 (e.g., including about 12 subcarriers 304).

FIG. 4A is a simplified diagram illustrating an example pretraining framework to pretrain a generative AI based deep learning language model on a dataset of tokenized wireless communication data, according to aspects described herein. In some aspects, the generative AI based language model may comprise at least an embedding layer 410 and a Transformer based language model 420a (referred to as “language model”). For example, the Transformer based language model 420a may comprise a Transformer decoder only.

In some aspects, a dataset of wireless communication data 403 may be obtained for training. For example, such dataset may comprise wireless communication data such as wireless configuration data at UE (and/or gNB) and other UE-gNB interaction data that represents link, protocol, or traffic level data between the UE and gNB in sequences of tokens. Each training sample may correspond to link activity in a particular slot in a communication scenario, including but not limited to UE CQI reports, decoded grants from gNB, UE HARQ A/N per grant, requests to schedule grants, absence of all activity, downlink rank, downlink modulation and coding scheme, etc. Wireless communication data 403 may be obtained from historical wireless communication data, simulated and/or synthetic communication data from a system-level simulation of a wireless network, and/or the like.

All such link, protocol, or traffic level configuration data may be tokenized, e.g., using one or more tokens or words to represent the actual configuration values. For example, during any slot, the UE may receive a grant or send a CQI report, and such activities may be represented as tokens or words. Special tokens may be used to indicate a slot end, a beginning of a sequence, other data that may not be signaled explicitly or the like. Such special tokens are referred to as first token, second token, etc., without loss of generality. For another example, each resource allocation token indicates the number of resource blocks (RBs).

An example of tokenized wireless communication data may be provided in Table 1 below:

TABLE 1
Wireless Configuration Tokenization

| Wireless vocabulary | Interpretation |
|---|---|
| UE_word1 | Buffer Status Report |
| UE_word2 | Channel State Feedback (CSF) Report |
| UE_word3 | HARQ Report |
| gNB_word1 | Grant in the Downlink |
| gNB_word2 | Grant in the Uplink |
| special_word1 | Beginning of sequence, or slot end |

In this way, the dataset 403 of tokenized wireless communication data (also referred to as “wireless protocol data”) may be used to pretrain a Transformed-based deep learning language model, in a similar way as a natural language model is trained using a corpus of natural language samples. The link, protocol or traffic level vocabulary 419 of the tokenized wireless communication data, as shown in one example in Table 1, may be referred to as “wireless protocol language.”

In some aspects, a training token sequence 404 from the training dataset of wireless communication dataset 403 may be input to the embedding layer 410, which in turn may map the tokens 404 to a set of embeddings, e.g., in a form of an embedding vector 405 which are dense numerical representations. For example, the embedding layer 410 may be a neural network module that functions as a lookup table to map integer indices, which represent words or tokens, to dense vectors, or embeddings. The embeddings 405 thus captures the relationships and similarities between input tokens in the training token sequence 404, and in turn captures relationships between different types of wireless signaling and configuration data that the tokens represent. The embeddings 405 may be adjusted (referred to as “learnable”) during a backpropagation pass during training.

In one exemplary aspect, the embedding layer 410 may be specific to a particular gNB, e.g., implemented or operated by a particular carrier, or the like. In this way, the embeddings 405 may be generated in a specific way corresponding to the particular carrier.

The learnable embedding vector 405 may then be passed to a language model 420a to generate an output conditional distribution of a next predicted token p (yt|yt−1, yt−2 . . . ) over the wireless language vocabulary 419 at a time instant t conditioned on the previously predicted tokens (e.g., before time t). For example, the language model 420a may or may not comprise a decoder-only Transformer-based architecture similar to OPT/GPT style LLMs. However, here, the language model 420a may or may not be pretrained with any natural language data.

For example, a decoder-only language model 420a may receive embeddings 405 and add positional encodings to these embeddings to provide information about the order of tokens in the original input sequence of tokens 404. The embeddings may then be passed into a multi-head masked self-attention mechanism that computes attention scores between each token and earlier tokens in the input sequence, but not future tokens in order to preserve causality. For instance, the attention score between two tokens measures the relevance or importance of one token to the other-if a first token has a high attention score with a second token, it means the first token heavily depends on or is influenced by the second token.

The decoder-only language model 420a may further comprise a fully-connected feed forward layer that which applies nonlinear transformations and refines the representation of the input sequence of tokens. The decoder-only language model 420a may further comprise a normalization layer and/or residual connections to stabilize the output from the feed-forward layer and improve gradient flow during training.

In some aspects, the decoder-only language model 420a comprises multiple stacked layers, with each layer refining the token representations through repeated attention and feed-forward processing. The final output of the last decoder layer of the decoder-only language model 420a is passed through a linear layer (or a projection layer) that maps the output to the vocabulary size, e.g., the wireless protocol vocabulary 419. A softmax function is then applied to calculate probabilities 421 for the next token.

The output distribution 421 of the language model 420a may correspond to predicted gNB side information that is not otherwise signaled to the UE, or link adaptation wireless configuration data or wireless protocol interaction data that UE can be operating at or communicating with the gNB, or the like.

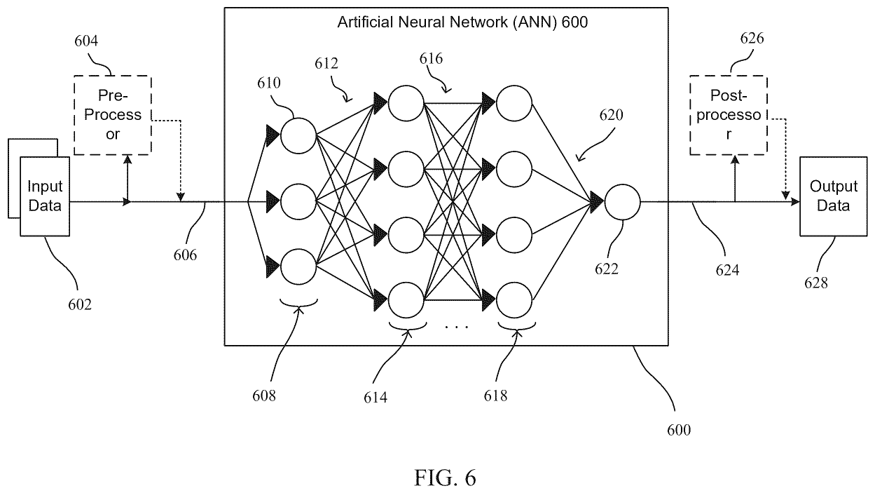

The output distribution 421 may then be used to compute a training loss 422, for example, by comparing with a ground-truth token sequence 413, e.g., the actual corresponding historical gNB-side information or the actual historical link adaptation configuration data from the training dataset 403. The training loss 422 may comprise any of a cross-entropy loss, an L-2 norm loss, a mean square error loss, or the like. Parameter or weights of the language model 420 or the embedding layer 410 may then be updated via a backpropagation path 414 by minimizing the training loss 422. Additional details of training a neural network model may be described below in relation to FIG. 6.

Here, the embedding layer 410 or the decoder-only language model 420a may only be trained by the dataset of wireless communication dataset 403, without being pretrained with any natural language data. In this way, the decoder-only language model 420a is pretrained to process wireless communication data in the form of sequence of tokens in a similar manner as the decoder-only language model 420a would have been pretrained for natural language processing.

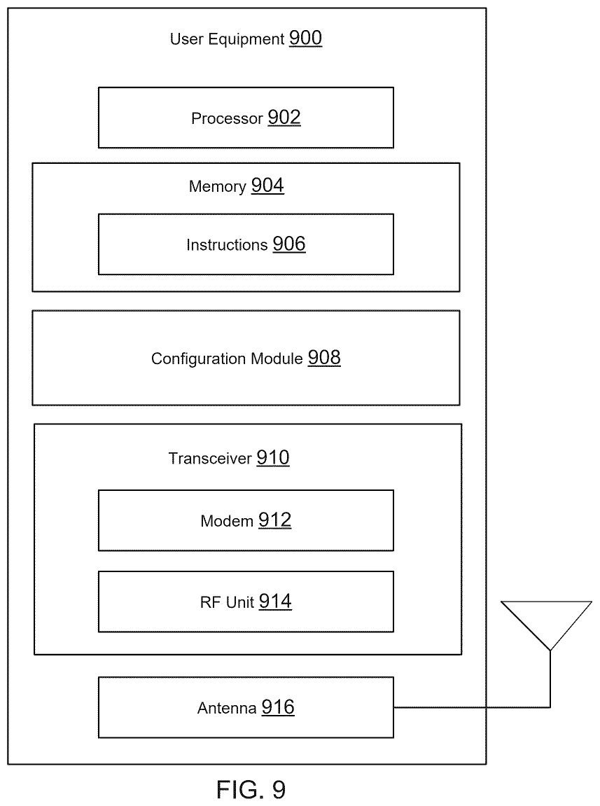

FIG. 4B is a simplified diagram illustrating using a generative AI based language model trained by the framework in FIG. 4A to predict wireless configuration data such as wireless communication data for a next slot, according to aspects described herein. In some aspects, the trained embedding layer 410 and the trained deep learning language model 420 may be deployed at the UE side, e.g., a user device operated by a user or any server that is in communication with the user device. An example structure of such UE side device or server may be described below in relation to FIG. 9.

In some aspects, the trained embedding layer 410 and the trained deep learning language model 420b may be operated by the UE side to predict wireless configuration data or wireless protocol interaction data that UE communicating with the gNB token by token, and slot by slot. For example, at a current slot, current wireless communication data representing current link/protocol/traffic level data between the UE and gNB (e.g., of the current slot) 402a, gNB side configuration data and/or other features that are available (e.g., from historical data or provided to UE via signaling, etc.) 402b, or previous gNB-UE interaction data 402c, or the like, may be tokenized and form an input token sequence 404, e.g., in a similar format to the training sequence 404 in FIG. 4A.

In some aspects, the input token sequence 404 may be combined into an input prompt for the trained embedding layer 410 and the trained language model 420b to generate an output. For example, the input token sequence 404 may have a sequence of (e.g., 1024) tokens appended with a token to indicate an end of the slot. During training as shown in FIG. 4A, the trained language model 420b has learnt the distributions implicit in the tokens in the dataset 403. Then at inference, the trained language model 420b may generate the predicted probability distribution 421 over the wireless vocabulary 419 that indicates a realistic future wireless configuration for a subsequent period of time such as the next number of slots.

Here, if yₜ denotes the target label for the network at token position t in the UE-gNB interaction, the predicted next token 428 is represented as ŷₜ|y_{t-1, t-2, . . . 0}, e.g., the t th predicted token is conditioned on the previous (t−1) tokens. For example, t can be 1 (for ctx_len=0) or 1024 (for ctx_len=1023 past tokens) tokens etc. In another example, the trained embedding layer 410 and the trained language model 420b may jointly generate an output conditioned on a particular communication scenario. In other words, a set of pre-defined diverse prompts, each representing different traffic parameters (arrival rate, file size, etc.) and gNB settings such as different delta CQI step, fairness parameters, gNB side delay, etc., may be combined into the input prompt to the trained embedding layer 410. For example, input token sequence 404 may comprise a prompt having a length of (e.g., 512) tokens describing a particular block error rate (BLER) setting. The trained embedding layer 410 and the trained language model 420b thus generate an output distribution 421 over the vocabulary of wireless protocol language, conditioned on a particular scenario described by these different traffic parameters. The generation of conditional output distribution 421 by pre-trained language model 420b may be performed in a similar manner as that with language model 420a in FIG. 4A.

In this way, the trained language model 420b may predict, for example, a future BLER depending on the BLER setting at the gNB which is reflected in the prompt that is incorporated in the input sequence 404.

In some aspects, the input prompt combining the input token sequence 404 is fed to the trained embedding layer 410, which in turn maps the input token sequence 404 to one or more embedding vectors 415. The embedding vector 415 may be fed to the trained language model 420b, which may then output a conditional probability distribution 421 over a vocabulary of “wireless protocol language” 419, conditioned on the previously outputted tokens.

Specifically, the trained language model 420b may auto-regressively predict a next token. For example, given the output conditional probability distribution 421, a sampler 425 may randomly sample a predicted next token 428 from the vocabulary 419 of “wireless protocol language” according to the distribution 421. The sampled next token 428 is in turn appended to the input to the trained language model 420b again. The trained language model 420b thus regressively outputs a conditional distribution again in response to the input combining the predicted token in the preceding time step. In this way, the trained language model 420b may generate a series of predicted tokens over time. The resulting sequence of predicted output tokens may indicate predicted wireless communication data such as wireless configuration data or wireless protocol interaction data that UE can be operating at or communicating with the gNB. In this way, the UE may configure communication with the gNB based on the sequence of predicted output tokens in future slots.

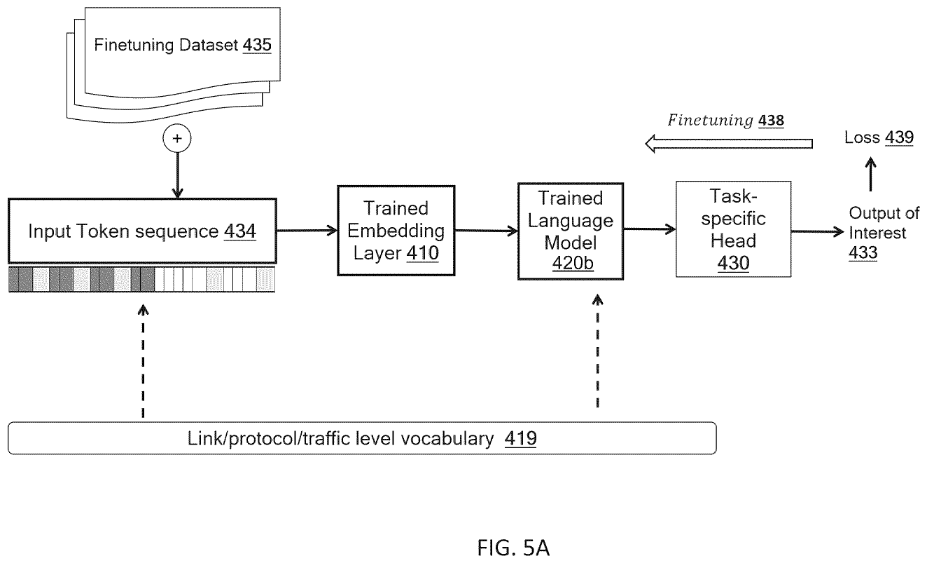

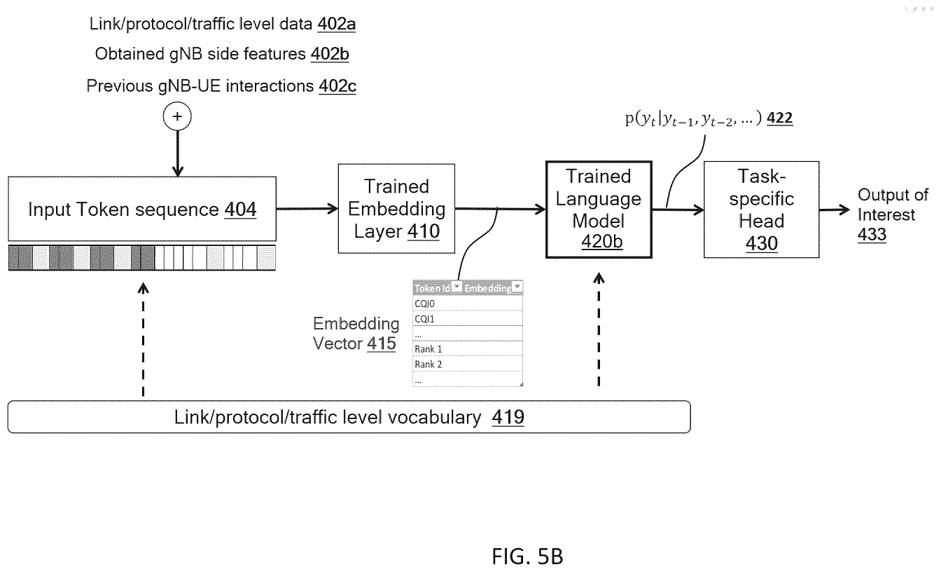

FIG. 5A is a simplified diagram illustrating an example training framework to finetune one or more task-specific neural network modules with the pretrained generative AI based learning language model trained in FIG. 4A on a dataset of specific tokenized wireless communication data, according to aspects described herein. In some aspects, in addition to predicting wireless signaling data as described in FIG. 4B, the trained language model 420b may be adapted to predict a specific output of interest, such as but not limited to throughput, latency, gNB excess capacity, block error rate (BLER), etc. To do so, a task-specific neural network, referred to as “head” or “adapter,” may be added on top of the trained language model 420b. For example, a task-specific head 430 is a modular neural network component (such as a multi-layer perceptron (MLP)) added to the trained language model 420b to fine-tune the trained language model 420b to handle a particular task or generate a particular type of output. The task-specific decoder head 430, such as one or more MLPs, may be integrated into a Transformer block of the trained language model 420b, or added at the decoder output of the trained language model 420b, or the like, to process and convert an intermediate representation produced by the trained language model 420b into a final output specific to the task at hand. For example, the task-specific decoder head 430 may generate a particular type of output of interest, such as but not limited to throughput, latency, gNB excess capacity, block error rate (BLER), etc.

In some aspects, as shown in FIG. 5A, a task-specific decoder head 430 is trained or finetuned together with the trained embedding layer 410 and the pretrained language model 420b. For example, one or more finetuning datasets 435 may be obtained, each containing wireless communication data of a particular scenario and corresponding throughput, latency, gNB excess capacity, block error rate (BLER), performance metric data, etc. In some aspects, the finetuning dataset 435 may be smaller in size than the dataset 403 in FIG. 4A, such that the finetuning of the task-specific head 430 is computationally efficient.

An input token sequence 434 from the finetuning dataset 435, representing link, protocol or traffic level configuration data, may be combined into an input prompt to be fed to the trained embedding layer 410. The trained embedding layer 410 may embed the input prompt in a similar way as described in FIGS. 4A-4B into an embedding vector. The combined trained language model 420b and the task-specific head 430 may generate an output of interest 433, such as any of throughput, latency, gNB excess capacity, block error rate (BLER), or the like performance metric. The output of interest 433 may be compared with the actual performance metric (the ground truth) of the same slot from the finetuning dataset 435 to compute a loss 439.

In some aspects, the trained embedding layer 410, the trained language model 420b and the task-specific head 430 may be jointly updated via the finetuning backpropagation path 438 by minimizing the loss 439. In another aspect, only the trained language model 420b and the task-specific head 430 may be jointly updated during backpropagation. In yet another aspect, only the task-specific head 430 is updated via the finetuning backpropagation path 438 while the trained embedding layer 410, the trained language model 420b remain frozen, e.g., the weights or parameters of the trained embedding layer 410, the trained language model 420b are unchanged. As the task-specific head 430 is usually much smaller in size than the trained language model 420b, e.g., fewer number of blocks and layers, fewer weights or parameters, etc., finetuning only the task-specific head 430 is computationally efficient.

In this way, different types of task-specific heads 430 may be efficiently finetuned to generate different types of outputs of interests 433. For example, a finetuned task-specific head may be used to predict whether the gNB is overloaded.

FIG. 5B is a simplified diagram illustrating using the finetuned task-specific neural network modules finetuned using the framework shown in FIG. 5A to predict one or more particular types of performance metrics, according to aspects described herein. In some aspects, given similar inputs 402a-402c as discussed in relation to FIG. 4B, the combination of trained embedding layer 410, trained language model 420b and the task-specific head 430 that have been partially or jointly finetuned as described in relation to FIG. 5A may generate an output of interest 433 specific to the task-specific head 430.

For example, the trained language model 430 may generate the conditional probability distribution 421 over prompts from the wireless language library 419 in a similar manner as described in FIG. 4B. The task-specific head 430 may receive the conditional probability distribution 421 and in turn generate a predicted output of interest 433 indicating a specific type of performance metric.

FIG. 6 is an illustrative block diagram of an example machine learning (ML) model represented by an artificial neural network (ANN) 600. One or more of the embedding layers 410, language model 420, or the task-specific head 430 described in FIGS. 4A-5B may each comprise a similar structure of ANN 600.

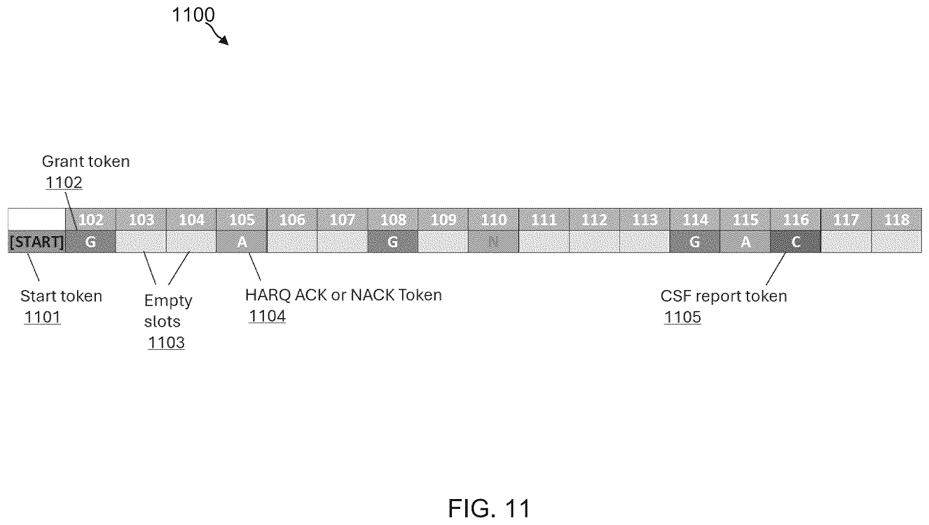

ANN 600 may receive input data 606 which may include one or more bits of data 602, pre-processed data output from pre-processor 604 (optional), or some combination thereof. Here, data 602 may include training data, verification data, application-related data, or the like, based, for example, on the stage of deployment of ANN 600. Pre-processor 604 may be included within ANN 600 in some other implementations. Pre-processor 604 may, for example, process all or a portion of data 602 which may result in some of data 602 being changed, replaced, deleted, etc. In some implementations, pre-processor 604 may add additional data to data 602. In some implementations, the pre-processor 604 may be a ML model, such as an ANN. For example, preprocessor 604 may collect historical wireless communication data, e.g., from one or more data providers, and tokenize the wireless communication data in the form of token sequences, such as the dataset 403 in FIG. 4A. Examples of converting raw wireless configuration data to a tokenized wireless protocol language may be described in relation to FIG. 11.

ANN 600 includes at least one first layer 608 of artificial neurons 610 to process input data 606 and provide resulting first layer data via connections or “edges” such as edges 612 to at least a portion of at least one second layer 614. Second layer 614 processes data received via edges 612 and provides second layer output data via edges 616 to at least a portion of at least one third layer 618. Third layer 618 processes data received via edges 616 and provides third layer output data via edges 620 to at least a portion of a final layer 622 including one or more neurons to provide output data 624. All or part of output data 624 may be further processed in some manner by (optional) post-processor 626. Thus, in certain examples, ANN 600 may provide output data 628 that is based on output data 624, post-processed data output from post-processor 626, or some combination thereof.

In some aspects, ANN 600 may comprise a Transformer-based architecture. For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of ANN 600 may project input embeddings at the layer into three different embedding spaces using weight matrices, referred to as Query (Q) representing what a token wants to attend to, Key (K) representing what this token offers as information and Value (V) representing the actual information carried by the token. The Q, K, V matrices contain tunable weights of ANN 600 that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based ANN 600 may receive a natural language input (such as a question) and generate a natural language output (such as an answer to the question). For another example, a Transformer-based ANN 600 may receive a natural language input (such as an instruction to write a code program) and generate a programming language output (such as a code program). With respect to FIGS. 4A-4B described herein, language model 420a may be pretrained using tokenized wireless communication data such that trained language model 420b may receive a sequence of tokens 404 representing wireless communication data and in turn generate an output sequence of tokens 428 representing wireless configuration data for a UE and/or a gNB.

In some aspects, a Transformer-based ANN 600 often entails a significant number of parameters (neural network weights) and computational complexity. For example, LLM such as Generative Pre-trained Transformer (GPT) 3 has 175 billion parameters, Text-to-Text Transfer Transformers (T5) has around 11 billion parameters. ANN 600 may comprise an architecture of mixed software and/or hardware, e.g., including an application-specific integrated circuit (ASIC) such as a Tensor Processing Unit (TPU).

Post-processor 626 may be included within ANN 600 in some other implementations. Post-processor 626 may, for example, process all or a portion of output data 624 which may result in output data 628 being different, at least in part, to output data 624, as result of data being changed, replaced, deleted, etc. In some implementations, post-processor 626 may be configured to add additional data to output data 624. In this example, second layer 614 and third layer 618 represent intermediate or hidden layers that may be arranged in a hierarchical or other like structure. Although not explicitly shown, there may be one or more further intermediate layers between the second layer 614 and the third layer 618. In some implementations, the post-processor 626 may be a ML model, such as an ANN.

The structure and training of artificial neurons 610 in the various layers may be tailored to specific requirements of an application. Within a given layer such as first layer 608, second layer 614, or third layer 618 of ANN 600, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 600. The weights and biases of ANN 600 may be adjusted during a training process or during operation of ANN 600. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 606. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 600, may be conducted using training data, e.g., dataset 403 in FIG. 4A. Training data may include one or more datasets which ANN 600 may use to identify patterns or relationships. Training data may represent various types of information, including written, visual, audio, environmental context, operational properties, etc. During training, the parameters (such as the weights and biases) of artificial neurons 610 may be changed, such as to minimize or otherwise reduce a loss function or a cost function. A training process may be repeated multiple times to fine-tune ANN 600 with each iteration.

Various ANN model structures are available for consideration. For example, in a feedforward ANN structure, each artificial neuron 610 in layer 614 receives information from the previous layer (such as, one or more artificial neurons 610 in layer 608) and produces information for the next layer (such as, one or more artificial neurons 610 in layer 618). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 600 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

In example aspects, an ML model may be trained prior to, or at some point following, operation of the ML model, such as ANN 600, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network unit, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network unit, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network unit) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network unit or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network unit such as a base station, or a disaggregated network unit such as a central unit (CU), a distributed unit (DU), a radio unit (RU), or the like.

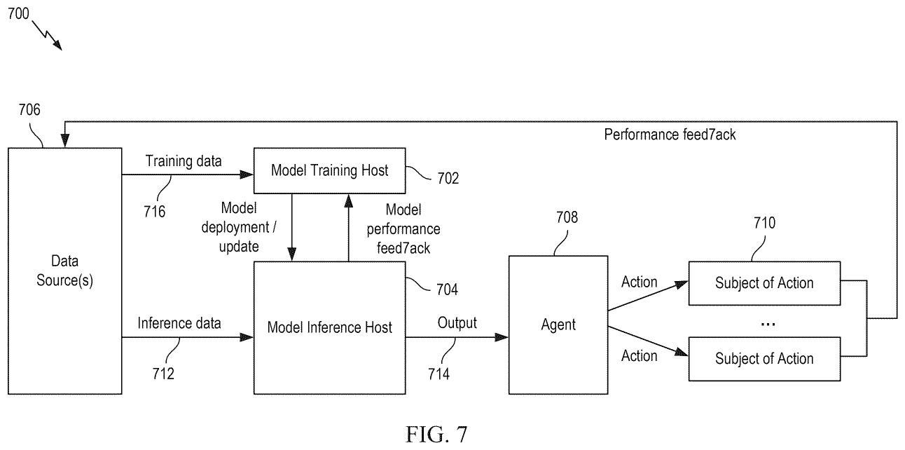

FIG. 7 is an illustrative block diagram of an example ML architecture 700 that may be used for wireless communications in any of the various implementations, processes, environments, networks, or use cases listed above. As illustrated, architecture 700 includes multiple logical entities, such as model training host 702, model inference host 704, data source(s) 706, and agent 708. Model inference host 704 is configured to run an ML model based on inference data 712 provided by data source(s) 706. Model inference host 704 may produce output 714, which may include a prediction or inference, such as a discrete or continuous value based on inference data 712, which may then be provided as input to the agent 708.

It is to be noted that the ML architecture 700 may be deployed at UE side such as a UE, or a UE-side server, or at gNB-side, such as a gNB or one or more distributed gNBs.

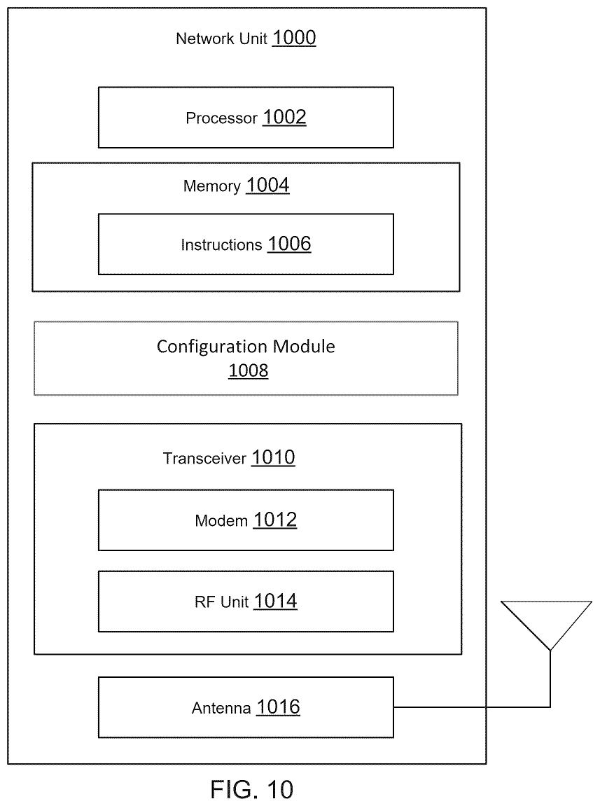

Agent 708 may represent an element or an entity of a wireless communication system including, for example, a radio access network (RAN), a wireless local area network, a device-to-device (D2D) communications system, etc. As an example, agent 708 may be a user equipment (UE 900 in FIG. 9), a base station (such as network unit 1000 in FIG. 10) or a disaggregated network unit (such as a centralized unit (CU), a distributed unit (DU), or a radio unit (RU), an access point, a wireless station, a RAN intelligent controller (RIC) in a cloud-based RAN, among some examples. Additionally, agent 708 also may be a type of agent that depends on the type of tasks performed by model inference host 704, the type of inference data 712 provided to model inference host 704, or the type of output 714 produced by model inference host 704. Agent 708 may perform one or more actions associated with receiving output 714 from model inference host 704. Agent 708 may indicate the one or more actions performed to at least one subject of action 710. In some cases, agent 708 and the subject of action 710 are the same entity.

Data can be collected from data sources 706 and may be used as training data 716 for training an ML model, or as inference data 712 for feeding an ML model inference operation. Data sources 706 may collect data from various subject of action 710 entities (such as, the UE or the network unit), and provide the collected data to a model training host 702 for ML model training. In some examples, if output 714 provided to agent 708 is inaccurate (or the accuracy is below an accuracy threshold), model training host 702 may provide feedback to model inference host 704 to modify or retrain the ML model used by model inference host 704, such as via an ML model deployment update.

Model training host 702 may be deployed at the same or a different entity than that in which model inference host 704 is deployed. For example, in order to offload model training processing, which can impact the performance of model inference host 704, model training host 702 may be deployed at a model server.

In some aspects, an ML model is deployed at or on a network unit (such as network unit 1000 in FIG. 10) for predicting wireless configuration data for future slots such as subsequent slots in a given subsequent period of time. More specifically, a model inference host, such as model inference host 704 in FIG. 7, may be deployed at or on the network unit.

In some other aspects, an ML model is deployed at or on a UE (such as UE, or a server that is communicatively coupled to the UE, collectively referred to as “UE side”) for predicting wireless configuration data for future slots such as subsequent slots in a given subsequent period of time. More specifically, a model inference host, such as model inference host 704 in FIG. 7, may be deployed at or on the UE side.

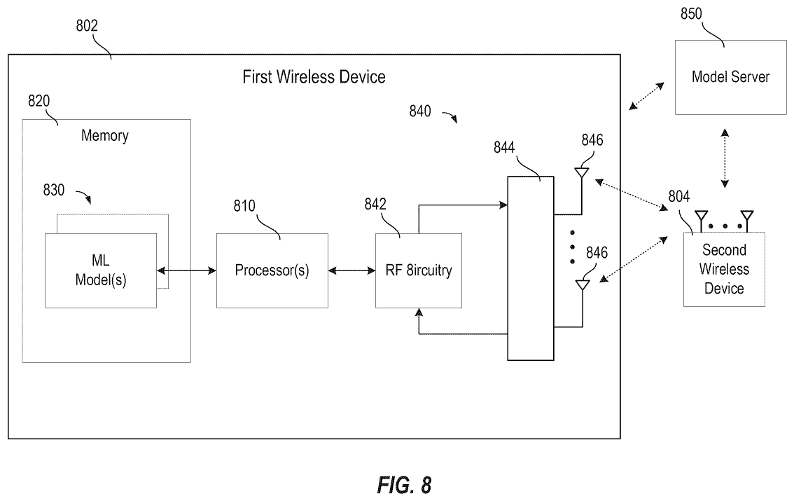

FIG. 8 is an illustrative block diagram of an example ML architecture of first wireless device 802 in communication with second wireless device 804. First wireless device 802 may be configured using ML model generated configuration data. Similarly, the second wireless device may be configured for using ML model generated configuration data. Note that the example ML architecture of first wireless device 802 may be applied to second wireless device 804, and vice versa.

First wireless device 802 may be, or may include, a chip, system on chip (SoC), chipset, package or device that includes one or more processors, processing blocks or processing elements (collectively “processor 810”) and one or more memory blocks or elements (collectively “memory 820”). Processor 810 may be coupled to transceiver 840, which includes radio frequency (RF) circuitry 842 coupled to antennas 846 via interface 844, for transmitting or receiving signals.

One or more ML models 830 (collectively “ML model 830”) may be stored in memory 820 and accessible to processor(s) 810. Individual or groups of ML models 830 may be associated with respective model identifiers. In some aspects, different ML models 830, which may optionally be associated with different model identifiers, may have different characteristics. One or more ML models 830 may be selected based on respective features, characteristics, or applications, as well as characteristics or conditions of first wireless device 802 (such as, a power state, a mobility state, a battery reserve, a temperature, etc.). For example, ML models 830 may have different inference data and output pairings (such as, different types of inference data produce different types of output), different levels of accuracies associated with the predictions, different latencies associated with producing the predictions, different ML model sizes, different coefficients, different parameters, etc.

Processor 810 may deploy ML models 830 to produce respective output data based on input data. For example, as shown in FIGS. 4A-5B, current wireless communication data representing current link/protocol/traffic level data between the UE and gNB (e.g., of the current slot) and gNB side features that are available (e.g., from historical data or provided to UE via signaling, etc.) may be tokenized and form an input token sequence. ML model 830 may then output a conditional probability distribution over a vocabulary of “wireless protocol language” as described in relation to FIGS. 4A-5B.

In some aspects, model server 850 may perform various ML management tasks for first wireless device 802 or second wireless device 804. For example, model server 850 may host various types or versions of ML models 830 for first wireless device 802 or second wireless device 804 to download. Model server 850 may monitor and evaluate the performance of ML model 830. Model server 850 may transmit signals or provide indications/instructions to activate or deactivate the use of a particular ML model at first wireless device 802 or second wireless device 804. Model server 850 may switch to a different ML model 850 being used at first wireless device 802 or second wireless device 804, and model server 850 may provide such an instruction to the respective first wireless device 802 or second wireless device 804. Model server 850 may operate as a model training host (such as model training host 702) and update ML model 830 using training data. In some cases, the model server 850 may operate as a data source (such as data source 706) to collect and host training data, inference data, performance feedback, etc., associated with ML model 830.

FIG. 9 is a block diagram of an exemplary UE 900 according to some aspects of the present disclosure. The UE 900 may be the UE 115 in the network 100 or 200 as discussed above. As shown, the UE 900 may include a processor 902, a memory 904, a configuration module 908, a transceiver 910 including a modem subsystem 912 and a radio frequency (RF) unit 914, and one or more antennas 916. These elements may be coupled with each other and in direct or indirect communication with each other, for example via one or more buses.

The processor 902 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), random access memory (RAM), magneto resistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 904 includes a non-transitory computer-readable medium. The memory 904 may store instructions 906. The instructions 906 may include instructions that, when executed by the processor 902, cause the processor 902 to perform the operations described herein with reference to the UEs 115 in connection with aspects of the present disclosure, for example, aspects of FIGS. 4-6. Instructions 906 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The configuration module 908 may be implemented via hardware, software, or combinations thereof. For example, the configuration module 908 may be implemented as a processor, circuit, or instructions 906 stored in the memory 904 and executed by the processor 902. In some aspects, the configuration module 908 may implement the aspects of FIGS. 4A-5B. For example, the configuration module 908 of a first UE (e.g., the UE 115 or 900) may configure wireless transmission using configuration tokens predicted by the trained language model 420b.

As shown, the transceiver 910 may include the modem subsystem 912 and the RF unit 914. The transceiver 910 can be configured to communicate bi-directionally with other devices, such as the BSs 105 or the UEs 115. The modem subsystem 912 may be configured to modulate or encode the data from the memory 904 and the according to a modulation and coding scheme (MCS), e.g., a low-density parity check (LDPC) coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or a BS 105. The RF unit 914 may be further configured to perform analog beamforming in conjunction with the digital beamforming. Although shown as integrated together in transceiver 910, the modem subsystem 912 and the RF unit 914 may be separate devices that are coupled together to enable the UE 900 to communicate with other devices.

The RF unit 914 may provide the modulated or processed data, e.g. data packets (or, more generally, data messages that may contain one or more data packets and other information), to the antennas 916 for transmission to one or more other devices. The antennas 916 may further receive data messages transmitted from other devices. The antennas 916 may provide the received data messages for processing or demodulation at the transceiver 910. The antennas 916 may include multiple antennas of similar or different designs in order to sustain multiple transmission links. The RF unit 914 may configure the antennas 916.

In some instances, the UE 900 can include multiple transceivers 910 implementing different RATs (e.g., NR and LTE). In some instances, the UE 900 can include a single transceiver 910 implementing multiple RATs (e.g., NR and LTE). In some instances, the transceiver 910 can include various components, where different combinations of components can implement RATs.

FIG. 10 is a block diagram of an exemplary network unit 1000 according to some aspects of the present disclosure. The network unit 1000 may be the BS 105, the CU 210, the DU 230, or the RU 240, as discussed above. As shown, the network unit 1000 may include a processor 1002, a memory 1004, a configuration module 1008, a transceiver 1010 including a modem subsystem 1012 and a RF unit 1014, and one or more antennas 1016. These elements may be coupled with each other and in direct or indirect communication with each other, for example via one or more buses. In a 5G NR, 5G+, 6G system or systems of future generations, network unit 1000 may correspond to a gNB as used throughout the disclosure.

The processor 1002 may have various features as a specific-type processor. For example, these may include a CPU, a DSP, an ASIC, a controller, a FPGA device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 1004 may include a non-transitory computer-readable medium. The memory 1004 may store instructions 1006. The instructions 1006 may include instructions that, when executed by the processor 1002, cause the processor 1002 to perform operations described herein, for example, aspects of FIGS. 4-6. Instructions 1006 may also be referred to as code, which may be interpreted broadly to include any type of computer-readable statement(s).

The configuration module 1008 may be implemented via hardware, software, or combinations thereof. For example, the configuration module 1008 may be implemented as a processor, circuit, or instructions 1006 stored in the memory 1004 and executed by the processor 1002.

In some aspects, the configuration module 1008 may host a generative AI based language model so as to implement the aspects of FIGS. 4A-5B to predict wireless configuration data. For example, the network unit 1000 may then decide to upgrade or downgrade the scheduling priority of one or more UEs based on the predicted wireless configuration data. Such scheduling priority information may be signaled to one or more UEs via transceiver 1010.

As shown, the transceiver 1010 may include the modem subsystem 1012 and the RF unit 1014. The transceiver 1010 can be configured to communicate bi-directionally with other devices, such as the UEs 115 or 600. The modem subsystem 1012 may be configured to modulate or encode data according to a MCS, e.g., a LDPC coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data from the modem subsystem 1012 (on outbound transmissions) or of transmissions originating from another source such as a UE 115 or UE 600. The RF unit 1014 may be further configured to perform analog beamforming in conjunction with the digital beamforming. Although shown as integrated together in transceiver 1010, the modem subsystem 1012 or the RF unit 1014 may be separate devices that are coupled together at the network unit 1000 to enable the network unit 1000 to communicate with other devices.

The RF unit 1014 may provide the modulated or processed data, e.g. data packets (or, more generally, data messages that may contain one or more data packets and other information), to the antennas 1016 for transmission to one or more other devices. This may include, for example, a configuration indicating a plurality of sub-slots within a slot according to aspects of the present disclosure. The antennas 1016 may further receive data messages transmitted from other devices and provide the received data messages for processing or demodulation at the transceiver 1010. The antennas 1016 may include multiple antennas of similar or different designs in order to sustain multiple transmission links.

In some instances, the network unit 1000 can include multiple transceivers 1010 implementing different RATs (e.g., NR and LTE). In some instances, the network unit 1000 can include a single transceiver 1010 implementing multiple RATs (e.g., NR and LTE). In some instances, the transceiver 1010 can include various components, where different combinations of components can implement RATs.

FIG. 11 provides an example diagram illustrating an example tokenized sequence representing wireless communication or configuration data similar to the input sequence of tokens described in FIGS. 4A-5B, according to aspects described herein. In some aspects as shown in FIG. 11, diagram 1100 shows an example flattened sequence of tokens across slot numbers 102 to 118. For example, the flattened sequence may comprise a start token 1101 indicating the start of the sequence, and a series of tokens indicating various wireless communication or configuration data, such as but not limited to including data such as the slot type, grant MCS, grant rank, reported HARQ, reported MCS, reported rank, etc. For example, the flattened sequence may comprise a first token 1102 indicating a grant for slot 102, empty slots 1103 for slot numbers 103-104, a second token 1104 indicating HARQ ACK or NACK token for slot 105, and a third token 1105 indicating a channel state feedback (CSF) report.

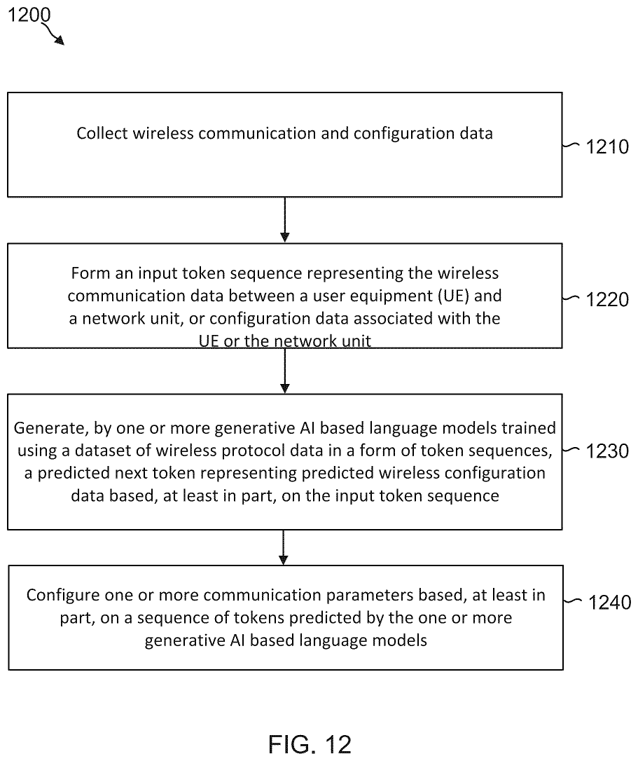

FIG. 12 is a flow diagram of a communication method 1200 according to some aspects of the present disclosure. Actions of the method 1200 can be executed by a computing device (e.g., a processor, processing circuit, or other suitable component) of an apparatus or other suitable means for performing the steps. For example, a UE, such as the UEs 115 or the UE 900, or a network unit 1000 (such as a gNB), may utilize one or more components, such as the processor 902, the memory 904, the configuration module 908, the transceiver 910, and the one or more antennas 916, to execute the steps of method 1200. For instance, the method may be performed by an application processor, a modem chipset, and SOC hosting an application processor and modem chipset, or the like.

As illustrated, the method 1200 includes a number of enumerated actions, but aspects of the method 1200 may include additional steps before, after, and in between the enumerated actions. In some aspects, one or more of the enumerated actions may be omitted or performed in a different order.

At block 1210, the UE may collect wireless communication data between UE and a network unit, or configuration data. For example, the wireless communication data comprises one or more of: UE-side wireless communication data that is observed by the UE at a current communication slot; network unit-side wireless communication data that is signaled to the UE at the current communication slot; or it may be the wireless communication data observed by the network unit corresponding to the data sent by all the UEs it is currently serving, and previous wireless communication data from previous communication slots retrieved from a memory.

At block 1220, the UE may form an input token sequence (e.g., 404 in FIGS. 4A-4B) representing the wireless communication data between UE and a network unit, configuration data associated with the UE or the network unit.

At block 1230, the UE may generate, by one or more generative AI based language models trained using a dataset (e.g., 403 in FIG. 4A) of wireless protocol data in a form of token sequences, a predicted next token (e.g., 428 in FIG. 4B) representing predicted wireless communication and/or configuration data based, at least in part, on the input token sequence. For example, the one or more generative AI based language models are implemented at the UE, or a server in communication with the UE. The predicted wireless communication and/or configuration data comprises synthetic configuration data associated the network unit, e.g., data such as network unit-side setting that is otherwise unavailable at the UE through network unit signaling at a current communication slot, e.g., one or more of: network unit scheduler parameters, a load on the network unit, link adaptation for an outer loop, a fair parameter of the network unit, a traffic presence of at least another UE, a class of traffic of at least another UE, an inference at the network unit with at least another UE, etc. Additional predicted wireless communication data may further comprise one or more of: a modulation coding scheme (MCS); a downlink rank indicator; a channel quality indicator (CQI); network unit scheduler parameters; raw channel measurement of different signals; a buffer status at the UE; a decode result of any uplink or downlink grant; a scheduling request the UE has made; a load on the network unit; link adaptation parameters for an outer loop; a fairness parameter of the network unit; a traffic presence of at least another UE; a class of traffic of at least another UE; a class or priority for different UEs the network unit is currently serving; or an inference at the network unit with at least another UE.

In some aspects, the one or more neural network language models may be trained using tokenized wireless protocol data only without being pretrained on any natural language data. The one or more neural network language models are trained using multiple datasets of wireless protocol data, each dataset corresponding to wireless protocol data belonging to a respective traffic type.

In some aspects, the one or more generative AI based language models comprise an embedding layer (e.g., 410 in FIG. 4B) to generate an embedding vector (e.g., 415 in FIG. 4B) from the input token sequence (e.g., 404 in FIG. 4B), and a model (e.g., 420b in FIG. 4B) to output a conditional probability distribution (e.g., 422 in FIG. 4B) over a vocabulary (e.g., 419 in FIG. 4B) of tokens representing different types or values of wireless signaling or configuration data conditioned. The predicted next token (e.g., 428 in FIG. 4B) is then sampled from the vocabulary of tokens according to the conditional probability distribution, and combined with the input prompt to auto-regressively generate the sequence of tokens conditioned on the embedding vector combined with previously predicted tokens.

In some aspects, the one or more generative AI based language models further comprise a task-specific neural network module (e.g., 430 in FIGS. 5A-5B) trained using an additional dataset of wireless protocol data and corresponding performance metrics, to generate a specific performance metric (e.g., 433 in FIG. 5B) of the wireless communication. For example, the task-specific neural network module is trained in conjunction with the one or more neural network language models to produce a training output while the one or more neural network language models remain frozen during backpropagation.

At block 1240, the UE may configure one or more communication parameters (e.g., by mapping predicted next tokens representing wireless configuration data to specific data fields for configuration at the UE according to at least Table 1) based, at least in part, on a sequence of tokens predicted by the one or more generative AI based language models. The UE may transmit, from the UE to the network unit, a capability update message indicating that the UE is capable of using at least one neural network to configure wireless communication with the network unit.

In one aspect, it is to be noted that although method 1200 described above is performed at UE for example, a similar method may be performed at the network unit (e.g., by configuration module 1008 shown in FIG. 10). For example, a generative AI based language model may be deployed at the network unit side. The network unit may perform steps similar to 1220 and 1230 to generate a predicted next token representing predicted wireless communication data for the network unit. The network unit may then configure one or more communication parameters (e.g., by mapping predicted next tokens representing wireless configuration data to specific data fields for configuration at the network unit) based, at least in part, on a sequence of tokens predicted by the one or more generative AI based language models. The network unit may then decide to upgrade or downgrade the scheduling priority of one or more UEs based on the predicted wireless configuration data, and signal the one or more UEs on the scheduling priority accordingly. In this way, AI based models such as language model 420a-b described in FIGS. 4A-4B may generate wireless configuration data that is otherwise not available to the UE or the gNB, to configure uplink and/or downlink wireless transmission at the UE or the gNB, respectively. Wireless technology is thus improved.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, at least one of A, B, or C can include at least one of A, or at least one of B, or at least one of C, or at least one of A and at least one of B, or at least one of A and at least one of C, or at least one of B and at least one of C, or at least one of A and at least one of B and at least one of C.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular implementations illustrated and described herein, as they are merely by way of some examples thereof, but rather, should be fully commensurate with that of the claims appended hereafter and their functional equivalents.

Various aspects are further described below:

Aspect 1. A user equipment (UE) of wireless communication, the UE comprising:
one or more memories; and
one or more processors, coupled to the one or more memories, configured to cause the UE to:
generate an input token sequence associated with one or more of wireless communication data between the UE and a network unit, configuration data associated with the UE, or configuration data associated with the network unit; obtain one or more predicted next tokens representing predicted wireless communication data from one or more generative artificial intelligence (AI) based language models using the input token sequence, the one or more generative AI-based language models pretrained with a dataset comprising data token sequences associated with wireless protocol data; and
generate one or more communication parameters for future wireless communication by the UE, based at least in part, on the one or more predicted next tokens.

Aspect 2. The UE of aspect 1, wherein the one or more generative artificial AI based language models are implemented at one or more of the UE, a server in communication with the UE, and the network unit.

Aspect 3. The UE of aspect 1 or 2, wherein the wireless communication data between the UE and the network unit comprises one or more of: UE-side wireless communication data that is observed by the UE at a current communication slot; network unit-side wireless communication data that is signaled to the UE at the current communication slot; previous wireless communication data from previous communication slots retrieved from a memory; or simulated or synthetic wireless data from system-level simulation.

Aspect 4. The UE of any of aspects 1 to 3, wherein the wireless communication data between the UE and the network unit comprises one or more of: a channel quality indicator (CQI) report; a decoded grant in an uplink or downlink from the network unit, the decoded grant indicative of one or more of a rank, a spectral efficiency, and a size of the grant; a UE hybrid automatic repeat request (HARQ) per grant; a raw channel measurement; a buffer status at the UE; a scheduling request; or an absence of all activity.

Aspect 5. The UE of any of aspects 1 to 4, wherein the predicted wireless communication data comprises at least one synthetic configuration data associated with the network unit.

Aspect 6. The UE of any of aspects 1 to 5, wherein the predicted wireless communication data comprises one or more of: a modulation coding scheme (MCS); a downlink rank indicator; a channel quality indicator (CQI); network unit scheduler parameters; raw channel measurement of different signals; a buffer status at the UE; a decode result of any uplink or downlink grant; a scheduling request the UE has made; a load on the network unit; link adaptation parameters for an outer loop; a fairness parameter of the network unit; a traffic presence of at least another UE; a class of traffic of at least another UE; a class or priority for different UEs the network unit is currently serving; or an inference at the network unit with at least another UE.

Aspect 7. The UE of any of aspects 1 to 6, wherein at least one of the one or more generative AI based language models is pretrained with a dataset consisting essentially of data token sequences associated with wireless protocol data.

Aspect 8. The UE of any of aspects 1 to 7, wherein at least one of the one or more generative AI based language models is pre-trained using multiple datasets, each dataset consisting essentially of data token sequences associated with wireless protocol data, and each dataset corresponding to wireless protocol data belonging to a respective traffic type.

Aspect 9. The UE of any of aspects 1 to 8, wherein at least one of the one or more generative AI based language models comprises an embedding layer associated with a particular network unit, wherein the one or more processors are further configured to cause the UE to:
generate, by the embedding layer, an embedding vector corresponding to the particular network unit from the input token sequence.

Aspect 10. The UE of aspect 9, wherein the one or more processors are further configured to cause the UE to: output a conditional probability distribution over a vocabulary of tokens representing different types or values of wireless communication data conditioned on the embedding vector. Aspect

Aspect 11. The UE of aspect 10, wherein the one or more processors are further configured to cause the UE to: sample the one or more predicted next tokens from the vocabulary of tokens according to the conditional probability distribution; combine the sampled one or more predicted next tokens into a next input sequence of tokens; and auto-regressively generate, by the one or more generative AI based language model, one or more updated predicted next tokens conditioned on the next input sequence of tokens.

Aspect 12. The UE of any of aspects 1 to 11, wherein the one or more processors are further configured to cause the UE to generate, by a task-specific neural network module trained using an additional dataset of wireless protocol data and corresponding performance metrics, a specific performance metric corresponding to the wireless communication data.

Aspect 13. The UE of aspect 12, wherein the task-specific neural network module is trained in conjunction with at least one of the one or more generative AI based language models to produce a training output while the at least one of the one or more generative AI based language models remain frozen during backpropagation.

Aspect 14. The UE of any of aspects 1 wherein to 13, wherein the one or more processors are further configured to cause the UE to transmit, from the UE to the network unit, a capability update message indicating that the UE is configured with at least one generative AI based language model for wireless communication or link adaptation.

Aspect 15. The UE of any of aspects 1 to 14, wherein the one or more processors are further configured to cause the UE to configure one or more future wireless transmissions with the network unit using the one or more communication parameters generated by the one or more generative AI-based language model.

Aspect 16. A network unit of wireless communication, the network unit comprising:
one or more memories; and
one or more processors, coupled to the one or more memories, configured to cause the network unit toto:
generate an input token sequence associated with one or more of wireless communication data between the network unit and one or more UEs that the network unit is serving, configuration data associated with the network unit or configuration data associated with the one or more UEs;
obtain one or more predicted next tokens representing predicted wireless communication data from one or more generative artificial intelligence (AI) based language models using the input token sequence, the one or more generative AI-based language models pretrained with a dataset comprising data token sequences associated with wireless protocol data; and generate one or more communication parameters for future wireless communication by the network unit, based at least in part, on the one or more predicted next tokens.

Aspect 17. The network unit of aspect 16, wherein the one or more generative AI language models are implemented at one or more of the network unit, or one or more distributed network units.

Aspect 18. The network unit of aspect 16 or 17, wherein the wireless communication data between the network unit and the one or more UEs comprises one or more of: network unit-side wireless communication data that is observed by the network unit at a current communication slot; UE-side wireless communication data that is signaled to the network unit from the one or more UEs that the network unit is serving at the current communication slot; previous wireless communication data from previous communication slots retrieved from a memory; or simulated or synthetic wireless data from system-level simulation.

Aspect 19. The network unit of any of aspects 16 to 18, wherein the predicted wireless communication data comprises at least one synthetic configuration data associated with at least one of the one or more UEs that the network unit is serving.

Aspect 20. The network unit of any of aspects 16 to 19, wherein the predicted wireless communication data comprises one or more of:
a modulation coding scheme (MCS);
a downlink rank indicator;
a channel quality indicator (CQI);
network unit scheduler parameters;
raw channel measurement of different signals;
a buffer status at the UE;
a decode result of any uplink or downlink grant;
a scheduling request the UE has made;
a load on the network unit;
link adaptation parameters for an outer loop;
a fairness parameter of the network unit;
a traffic presence of at least another UE;
a class of traffic of at least another UE;
a class or priority for one or more UEs the network unit is currently serving; or an inference at the network unit with at least another UE.

Aspect 21. The network unit of any of aspects 16 to 20, wherein at least one of the one or more generative AI based language models is pretrained with a dataset consisting essentially of data token sequences associated with wireless protocol data.

Aspect 22. The network unit of any of aspects 16 to 21, wherein at least one of the one or more generative AI based language models is pre-trained using multiple datasets, each dataset consisting essentially of data token sequences associated with wireless protocol data, and each dataset corresponding to wireless protocol data belonging to a respective traffic type.

Aspect 23. The network unit of any of aspects 16 to 22, wherein at least one of the one or more generative AI based language models comprises an embedding layer that is specific to the network unit, wherein the one or more processors are further configured to cause the network unit to generate, by the embedding layer, an embedding vector that is specific to the network unit, from the input token sequence.

Aspect 24. The network unit of aspect 23, wherein the one or more processors are further configured to cause the network unit to output a conditional probability distribution over a vocabulary of tokens representing different types or values of wireless communication data conditioned on the embedding vector.

Aspect 25 The network unit of aspect 24, wherein the one or more processors are further configured to cause the network unit to: sample the one or more predicted next tokens from the vocabulary of tokens according to the conditional probability distribution; combining the sampled one or more predicted next tokens into a next input sequence of tokens; and auto-regressively generate, by the one or more generative AI based language model, one or more updated predicted next tokens conditioned on the next input sequence of tokens.

Aspect 26. The network unit of any of aspects 16 to 25, wherein the one or more processors are further configured to cause the network unit to: generate, by a task-specific neural network module trained using an additional dataset of wireless protocol data and corresponding performance metrics, a specific performance metric corresponding to the wireless communication data between the network unit and the one or more UEs.

Aspect 27. The network unit of aspect 26, wherein the task-specific neural network module is trained in conjunction with at least one of the one or more generative AI based language models to produce a training output while the at least one of the one or more generative AI based language models remain frozen during backpropagation.

Aspect 28. The network unit of aspect 27, wherein the one or more processors are further configured to cause the network unit to: receive, from at least one of the one or more UEs at the network unit, a capability update message indicating that the at least one UE is equipped with at least one generative AI based language model for wireless communication or link adaptation.

Aspect 29. The network unit of aspect 28, wherein the one or more processors are further configured to cause the network unit to: configure one or more future wireless transmissions with the one or more UEs using the one or more communication parameters generated by the one or more generative AI-based language model.

Aspect 30. The network unit of aspect 29, wherein the one or more processors are further configured to cause the network unit toto: signal, to at least one of the one or more UEs, an updated scheduling priority associated with the at least one of the one or more UEs based on the one or more communication parameters.

What is claimed is:

1. A user equipment (UE) for wireless communication, the UE comprising:
one or more memories; and
one or more processors, coupled to the one or more memories, the one or more processors configured to cause the UE to:
generate an input token sequence associated with one or more of: wireless communication data between the UE and a network unit, configuration data associated with the UE, or configuration data associated with the network unit;
obtain one or more predicted next tokens representing predicted wireless communication data from one or more generative artificial intelligence (AI) based language models using the input token sequence, wherein the one or more generative AI based language models are pretrained with a dataset comprising data token sequences associated with wireless protocol data; and
generate one or more communication parameters for future wireless communication by the UE, based at least in part on the one or more predicted next tokens.

2. The UE of claim 1, wherein the one or more generative AI based language models are implemented at one or more of: the UE, a server in communication with the UE, or the network unit.

3. The UE of claim 1, wherein the wireless communication data between the UE and the network unit comprises one or more of:
UE-side wireless communication data that is observed by the UE at a current communication slot;
network-side wireless communication data that is signaled to the UE at the current communication slot;
previous wireless communication data from previous communication slots retrieved from a memory; or
simulated or synthetic wireless data.

4. The UE of claim 1, wherein the wireless communication data between the UE and the network unit comprises one or more of:
a channel quality indicator (CQI) report;
a decoded grant from the network unit, the decoded grant indicative of one or more of: a rank, a spectral efficiency, or a size of the grant;
a UE hybrid automatic repeat request (HARQ) per grant;
a raw channel measurement;
a buffer status at the UE;
a scheduling request; or
an absence of all activity.

5. The UE of claim 1, wherein the predicted wireless communication data comprises synthetic configuration data associated with the network unit.

6. The UE of claim 1, wherein the predicted wireless communication data comprises one or more of:
a modulation coding scheme (MCS);
a downlink rank indicator;
a channel quality indicator (CQI);
network unit scheduler parameters;
raw channel measurement of different signals;
a buffer status at the UE;
a decode result of any uplink or downlink grant;
a scheduling request the UE has made;
a load on the network unit;
link adaptation parameters for an outer loop;
a fairness parameter of the network unit;
a traffic presence of at least another UE;
a class of traffic of at least another UE;
a class or priority for different UEs the network unit is currently serving; or
an inference at the network unit with at least another UE.

7. The UE of claim 1, wherein at least one of the one or more generative AI based language models is pretrained with the dataset consisting essentially of data token sequences associated with wireless protocol data.

8. The UE of claim 1, wherein at least one of the one or more generative AI based language models is pretrained using multiple datasets, each dataset consisting essentially of data token sequences associated with wireless protocol data, and each dataset corresponding to wireless protocol data belonging to a respective traffic type.

9. The UE of claim 1, wherein at least one of the one or more generative AI based language models comprises an embedding layer associated with a particular network unit, wherein the one or more processors are further configured to cause the UE to:
generate, by the embedding layer, an embedding vector corresponding to the particular network unit from the input token sequence.

10. The UE of claim 9, wherein the one or more predicted next tokens are associated with a conditional probability distribution over a vocabulary of tokens representing different types or values of wireless communication data conditioned on the embedding vector.

11. The UE of claim 10, wherein the one or more processors are further configured to cause the UE to:
sample the one or more predicted next tokens from the vocabulary of tokens according to the conditional probability distribution;
combine the sampled one or more predicted next tokens into a next input sequence of tokens; and
auto-regressively generate, using the one or more generative AI based language models, one or more updated predicted next tokens conditioned on the next input sequence of tokens.

12. The UE of claim 1, the one or more processors are further configured to cause the UE to:
generate by a task-specific neural network module trained using an additional dataset of wireless protocol data and corresponding performance metrics, a specific performance metric corresponding to the wireless communication data.

13. The UE of claim 12, wherein the task-specific neural network module is trained in conjunction with at least one of the one or more generative AI based language models to produce a training output while the at least one of the one or more generative AI based language models remain frozen during backpropagation.

14. The UE of claim 1, wherein the one or more processors are further configured to cause the UE toto:
transmit, to the network unit, a capability update message indicating that the UE is configured with at least one generative AI based language model for wireless communication or link adaptation.

15. The UE of claim 1, wherein the one or more processors are further configured to cause the UE to:
configure one or more future wireless transmissions with the network unit using the one or more communication parameters generated by the one or more generative AI-based language model.

16. A network unit for wireless communication, the network unit comprising:
one or more memories; and
one or more processors, coupled to the one or more memories, the one or more memories configured to cause the network unit toto:
generate an input token sequence associated with one or more of: wireless communication data between the network unit and one or more UEs that the network unit is serving, configuration data associated with the network unit or configuration data associated with the one or more UEs;
obtain one or more predicted next tokens representing predicted wireless communication data from one or more generative artificial intelligence (AI) based language models using the input token sequence, wherein the one or more generative AI-based language models are pretrained with a dataset comprising data token sequences associated with wireless protocol data; and
generate one or more communication parameters for future wireless communication by the network unit, based at least in part on the one or more predicted next tokens.

17. The network unit of claim 16, wherein the one or more generative AI based language models are implemented at one or more of: the network unit, or one or more distributed network units.

18. The network unit of claim 16, wherein the wireless communication data between the network unit and the one or more UEs comprises one or more of:
network unit-side wireless communication data that is observed by the network unit at a current communication slot;
UE-side wireless communication data that is signaled to the network unit from the one or more UEs that the network unit is serving at the current communication slot;
previous wireless communication data from previous communication slots retrieved from a memory; or
simulated or synthetic wireless data from system-level simulation.

19. The network unit of claim 16, wherein the predicted wireless communication data comprises at least one synthetic configuration data associated with at least one of the one or more UEs that the network unit is serving.

20. The network unit of claim 16, wherein the predicted wireless communication data comprises one or more of:
a modulation coding scheme (MCS);
a downlink rank indicator;
a channel quality indicator (CQI);
network unit scheduler parameters;
raw channel measurement of different signals;
a buffer status at the UE;
a decode result of any uplink or downlink grant;
a scheduling request the UE has made;
a load on the network unit;
link adaptation parameters for an outer loop;
a fairness parameter of the network unit;
a traffic presence of at least another UE;
a class of traffic of at least another UE;
a class or priority for one or more UEs the network unit is currently serving; or
an inference at the network unit with at least another UE.

21. The network unit of claim 16, wherein at least one of the one or more generative AI based language models is pretrained with the dataset consisting essentially of data token sequences associated with wireless protocol data.

22. The network unit of claim 16, wherein at least one of the one or more generative AI based language models is pre-trained using multiple datasets, each dataset consisting essentially of data token sequences associated with wireless protocol data, and each dataset corresponding to wireless protocol data belonging to a respective traffic type.

23. The network unit of claim 16, wherein at least one of the one or more generative AI based language models comprises an embedding layer that is specific to the network unit, wherein the one or more processors are further configured to cause the network unit to:
generate, by the embedding layer, an embedding vector that is specific to the network unit, from the input token sequence.

24. The network unit of claim 23, wherein the one or more predicted next tokens are associated with a conditional probability distribution over a vocabulary of tokens representing different types or values of wireless communication data conditioned on the embedding vector.

25. The network unit of claim 24, wherein the one or more processors are further configured to cause the network unit toto:
sample the one or more predicted next tokens from the vocabulary of tokens according to the conditional probability distribution;
combine the sampled one or more predicted next tokens into a next input sequence of tokens; and
auto-regressively generate, by the one or more generative AI based language models, one or more updated predicted next tokens conditioned on the next input sequence of tokens.

26. The network unit of claim 16, wherein the one or more processors are further configured to cause the network unit toto:
generate, by a task-specific neural network module trained using an additional dataset of wireless protocol data and corresponding performance metrics, a specific performance metric corresponding to the wireless communication data between the network unit and the one or more UEs.

27. The network unit of claim 26, wherein the task-specific neural network module is trained in conjunction with at least one of the one or more generative AI based language models to produce a training output while the at least one of the one or more generative AI based language models remain frozen during backpropagation.

28. The network unit of claim 27, wherein the one or more processors are further configured to cause the network unit to:
receive, from at least one of the one or more UEs, a capability update message indicating that the at least one UE is configured with at least one generative AI based language model for wireless communication or link adaptation.

29. The network unit of claim 28, wherein the one or more processors are further configured to cause the network unit to:
configure one or more future wireless transmissions with the one or more UEs using the one or more communication parameters generated by the one or more generative AI-based language models.

30. The network unit of claim 29, wherein the one or more processors are further configured to cause the network unit to:
signal, to at least one of the one or more UEs, an updated scheduling priority associated with the at least one of the one or more UEs based on the one or more communication parameters.

31. A method of wireless communication at a user equipment (UE), the method comprising:
generating an input token sequence associated with one or more of: wireless communication data between the UE and a network unit, configuration data associated with the UE, or configuration data associated with the network unit;
obtaining one or more predicted next tokens representing predicted wireless communication data from one or more generative artificial intelligence (AI) based language models using the input token sequence, wherein the one or more generative AI-based language models are pretrained with a dataset comprising data token sequences associated with wireless protocol data; and
generating one or more communication parameters for future wireless communication by the UE, based at least in part on the one or more predicted next tokens.

32. A method of wireless communication at a network unit, the method comprising:
generating an input token sequence associated with one or more of wireless communication data between the network unit and one or more UEs that the network unit is serving, configuration data associated with the network unit or configuration data associated with the one or more UEs;
obtaining one or more predicted next tokens representing predicted wireless communication data from one or more generative artificial intelligence (AI) based language models using the input token sequence, wherein the one or more generative AI-based language models are pretrained with a dataset comprising data token sequences associated with wireless protocol data; and
generating one or more communication parameters for future wireless communication by the network unit, based at least in part, on the one or more predicted next tokens.
